(19) United States
(12) Patent Application Publication
(10) Pub. No.: US 2025/0239030 A1
(43) Pub. Date: Jul. 24, 2025

(54) VERTEX POSE ADJUSTMENT WITH PASSTHROUGH AND TIME-WARP TRANSFORMATIONS FOR VIDEO SEE-THROUGH (VST) EXTENDED REALITY (XR)

(71) Applicant: Samsung Electronics Co., Ltd., Suwon-si (KR)

(72) Inventors: Yingen Xiong, Mountain View, CA (US); Christopher A. Peri, Mountain View, CA (US)

(21) Appl. No.: 19/022,906

(22) Filed: Jan. 15, 2025

Related U.S. Application Data
(60) Provisional application No. 63/622,874, filed on Jan. 19, 2024.

(51) Int. Cl. G06T 19/00; G06T 17/20; G06T 19/20

(52) U.S. Cl. CPC G06T 19/006; G06T 17/205; G06T 19/20; G06T 2219/2004

(57) ABSTRACT

A method includes determining at an extended reality (XR) device, a first set of vertex adjustment values of a distortion mesh and receiving image frame data of a scene captured at a first time and at a first head pose using a see-through camera of the XR device. The method further includes applying the first set of vertex adjustment values of the distortion mesh to the image frame data to obtain intermediate image data, and predicting a second head pose at a second time subsequent to the first time. The method also includes generating, based on the predicted second head pose, a second set of vertex adjustment values of the distortion mesh, applying the second set of vertex adjustment values of the distortion mesh to the intermediate image data to generate a rendered virtual frame and displaying the rendered virtual frame by the XR device at the second time.

### CROSS-REFERENCE TO RELATED APPLICATIONS AND PRIORITY CLAIM

This application claims priority under 35 U.S.C. § 119 (e) to U.S. Provisional Patent Application No. 63/622,874 filed Jan. 19, 2024, which is hereby incorporated by reference in its entirety.

### TECHNICAL FIELD

This disclosure relates generally to extended reality (XR) systems and processes. More specifically, this disclosure relates to vertex pose adjustment with passthrough and time-warp transformations in video see-through (VST) XR.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to vertex pose adjustment with passthrough and time-warp transformations in video see-through (VST) XR.

In a first embodiment, a method includes determining, using at least one processing device of an extended reality (XR) device, a first set of vertex adjustment values of a distortion mesh and receiving, using the at least one processing device, image frame data of a scene captured at a first time and at a first head pose using a see-through camera of the XR device. The method further includes applying, using the at least one processing device, the first set of vertex adjustment values of the distortion mesh to the image frame data to obtain intermediate image data, and predicting, using the at least one processing device, a second head pose at a second time subsequent to the first time. The method also includes generating, using the at least one processing device, based on the predicted second head pose, a second set of vertex adjustment values of the distortion mesh, applying, using the at least one processing device, the second set of vertex adjustment values of the distortion mesh to the intermediate image data to generate a rendered virtual frame and displaying the rendered virtual frame by the XR device at the second time, the rendered virtual frame comprising a corrected view of the scene.

In a second embodiment, an XR device includes at least one display, a see-through camera and at least one processing device. The at least one processing device is configured to determine a first set of vertex adjustment values of a distortion mesh, receive image frame data of a scene captured at a first time and at a first head pose by the see-through camera and apply the first set of vertex adjustment values of the distortion mesh to the image frame data to obtain intermediate image data. The at least one processing device is further configured to predict, a second head pose at a second time subsequent to the first time, generate, based on the predicted second head pose, a second set of vertex adjustment values of the distortion mesh, apply the second set of vertex adjustment values of the distortion mesh to the intermediate image data to generate a rendered virtual frame, and display at the at least one display, the rendered virtual frame by the XR device at the second time, the rendered virtual frame comprising a corrected view of the scene.

In a third embodiment, a non-transitory machine readable medium contains instructions that when executed cause at least one processor to determine a first set of vertex adjustment values of a distortion mesh, receive, from a see-through camera of an XR device, image frame data of a scene captured at a first time and at a first head pose by the see-through camera, and apply the first set of vertex adjustment values of the distortion mesh to the image frame data to obtain intermediate image data. When executed, the instructions further cause the at least one processing device to predict, a second head pose at a second time subsequent to the first time generate, based on the predicted second head pose, a second set of vertex adjustment values of the distortion mesh, apply the second set of vertex adjustment values of the distortion mesh to the intermediate image data to generate a rendered virtual frame, and display, at least one display of the XR device, the rendered virtual frame by the XR device at the second time, the rendered virtual frame comprising a corrected view of the scene.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example of applying vertex adjustment values to a distortion map to correct image data;

FIG. 3 illustrates an example pipeline for vertex pose adjustment with passthrough and time-warp transformations in video see-through (VST) XR in accordance with this disclosure;

FIG. 4 illustrates an example of vertex pose adjustment and time warp transformation in accordance with this disclosure;

FIG. 5 illustrates an example pipeline for vertex pose adjustment with passthrough and time-warp transformations in video see-through (VST) XR in accordance with this disclosure;

FIG. 6 illustrates an example pipeline for vertex pose adjustment with passthrough and time-warp transformations in video see-through (VST) XR in accordance with this disclosure; and

FIG. 7 illustrates an example method for vertex pose adjustment with passthrough and time-warp transformations in video see-through (VST) XR in accordance with this disclosure in accordance with this disclosure.

### DETAILED DESCRIPTION

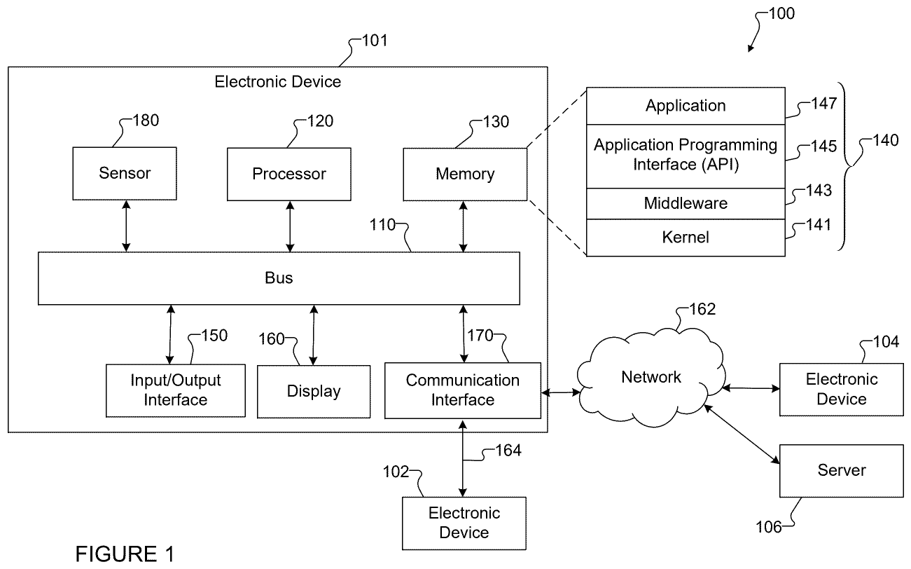

FIGS. 1 through 7, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video see-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

Viewpoint correction, also known as viewpoint matching, is often a useful or important operation in VST XR pipelines. Viewpoint matching typically refers to a process for creating video frames that are presented at a user's eye viewpoint locations using video frames captured at see-through camera viewpoint locations, which allows the user to feel as if the sec-through cameras are positioned at the user's eye viewpoint locations, rather. Among other things, viewpoint matching can involve depth-based reprojection in which objects within a scene are reprojected into virtual views based on the objects' depths within the scene. However, depth-based reprojection may require large amounts of computational resources (such as processing and memory resources) in order to reconstruct depths and perform depth reprojection, which can become particularly problematic at higher video resolutions (such as 4K resolutions and above). Moreover, depth-based reprojection may create latencies in VST XR pipelines, consume limited battery resources, generate excess heat at a head-worn device, or can cause noticeable delays or other issues (for example, motion sickness) for users.

In many cases, viewpoint matching is one of a plurality of static corrections which need to be implemented by a rendering pipeline in order to provide a satisfactory VST XR experience. As used in this disclosure, the expression “static corrections” encompasses corrections of differences between how a scene appears through a see-through camera, and a ground truth view (for example, through a human eye or a normal lens) of the same scene which are not dependent on dynamic factors (for example, the color mix of the objects in the video frame of the scene, or pose changes of the viewer). Further examples of static corrections which typically need to be performed on image data obtained from a see-through camera before display to a user include corrections for lens distortions. Many XR devices use see-through cameras with fisheye lenses, which have the benefit of capturing data across wide fields of view, but at the cost of significant distortion in the initially obtained video frames, which, left uncorrected, would diminish a viewer's XR viewing experience.

In addition to performing static corrections, providing a satisfactory XR viewing experience typically requires performing dynamic corrections of the video frame. As used in this disclosure, the expression “dynamic correction” encompasses corrections for factors specific to one or more conditions obtained over the interval between capturing a video frame by a see-through camera and displaying a XR video frame based on the captured frame. When combined with excessive latency in rendering XR video frames, motion effects (for example, a user turning her head) can create a disparity between the perspective of the images presented through the pass-through XR display and the perspective expected by the user based on the user's own sense of proprioception. Typically, the greater the mismatch between the perspective of the pass-through view of a scene presented in an XR display and the user's native understanding of the user's viewing perspective, the worse the XR viewing experience. Further, for many users, perceptible mismatches between the perspective of the XR display and their perceived current perspective can induce motion sickness in the user, which is particularly undesirable.

This disclosure provides examples of apparatus, method and computer-executable program code for vertex pose adjustment with passthrough and time-warp transformations for VST XR. As described in more detail below, locations within an image frame, including image frames captured by a see-through camera, a camera with a normal lens, or a rendered XR frame can be mapped to positions in an isometric grid, wherein the position comprises a point of intersection (also known as a vertex) between projections along a fixed value of a coordinate system. For example, in a Cartesian coordinate system, the vertices comprise corners of a grid paralleling the x and y axes. Similarly, in a polar coordinate system, the vertices comprise the intersections between rays emanating from the origin of the system and circles of specified radii. The same object in a scene can, due to persistent, or static factors, as well as context-dependent dynamic factors, occupy different coordinate values in image data obtained by a see-through camera lens and a normal lens projection (i.e., a camera projection generally corresponding to the field of view of a human eye). Thus, in order for image data from a see-through camera lens to be rendered to match image data from a normal lens situated at a user's eye, the vertices of the coordinate system of see-through camera lens need to be corrected to match those of the coordinate system of the normal lens view. Additionally, because correcting the coordinate system can be computationally intensive and is typically performed over human-perceptible processing intervals, it is beneficial that correction of the see-through camera image data be implemented in a way that the corrected image is projected from a viewpoint that corresponds to an XR device wearer's understanding of their viewpoint at the time.

Certain embodiments according to the present disclosure reduce the computational load and processing time associated with performing static and dynamic correction of the vertices of a coordinate system of a see-through camera and reducing discrepancies between the viewpoint perspective of the presented XR display, and the viewpoint perspective expected by the user based on their own capacity for proprioception.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to vertex pose adjustment with passthrough and time-warp transformations for VST XR.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform vertex pose adjustment with passthrough and time-warp transformations for VST XR. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 include cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102, 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102, 104 or server 106). Further, according to certain embodiments of this disclosure, when the electronic device 101 should perform some function or service automatically or at a request, the electronic device 101, instead of executing the function or service on its own or additionally, can request another device (such as electronic devices 102, 104 or server 106) to perform at least some functions associated therewith. The other electronic device (such as electronic devices 102, 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to depth-varying reprojection passthrough in VST XR.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

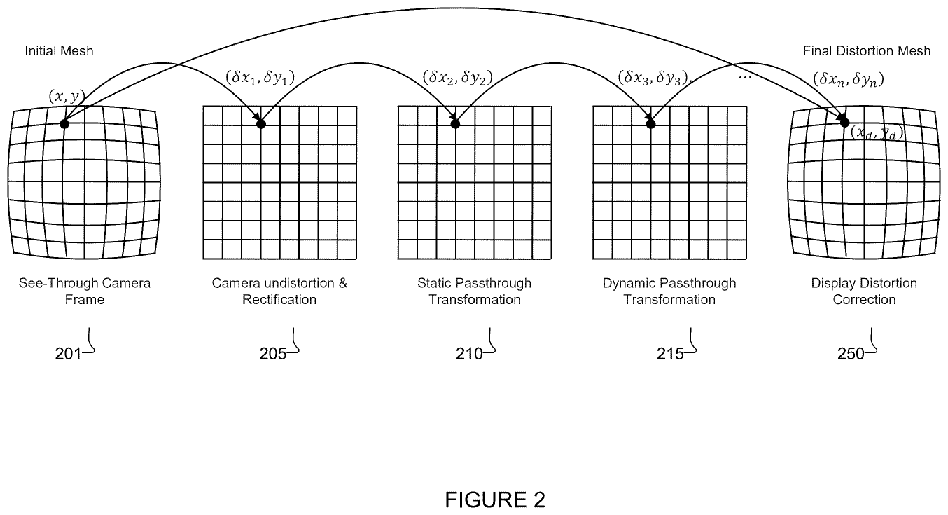

FIG. 2 illustrates an example of corrections applied to a see-through camera image frame based on applying vertex adjustment values to correct a distortion mesh. For ease of explanation, the distortion meshes and corrections described with reference to FIG. 2 are described as being performed by or implemented using the electronic device 101 in the network configuration 100 of FIG. 1. However, the operations described with reference to FIG. 2 may be implemented using any other suitable device(s) and in any other suitable system(s), such as the server 106.

As shown in FIG. 2, the see-through camera of an XR device can capture image frame data of a scene, wherein the intrinsics of the camera, such as the lens shape and other focal properties of the see-through camera create distortions in the image frame data of the scene. For example, the wide field of view provided by fisheye lenses comes at the cost of the raw image data of a scene appearing significantly distorted relative to how the same scene would appear through the lens of the human eye. Specifically, image frame data appears “curvy” relative to a human eye view of the same scene, with parallel lines in the scene becoming increasingly curved at points away from the center of the image, and points at the center of the image appearing excessively close relative to a human eye view.

As shown in FIG. 2, the distortions to the image frame data created by the intrinsics of the see-through camera, and other static and dynamic effects cause points in the image frame data to appear distorted—as if mapped to a non-rectilinear coordinate grid. This distortion can be readily observed in images of checkerboards, test cards and other rectilinear grids obtained by cameras fisheye or wide-angle lenses. Referring to the illustrative example of FIG. 2, locations within the image frame data can be described as being mapped to coordinates (x, y) in an initial mesh 201. The difference between the coordinate values of locations in initial mesh 201 and a distortion mesh 250 which accounts for the distortions produced by the intrinsics of the lens and static and dynamic effects can be given by:

$$\{ \begin{matrix}{x}_{d} = x + δ {x}_{1} + δ {x}_{2} + δ {x}_{3} + … + δ {x}_{n} \\ {y}_{d} = y + δ {y}_{1} + δ {y}_{2} + δ {y}_{3} + … + δ {y}_{n}\end{matrix}$$

Where (δx₁, δy₁), (δx₂, δy₂), (δx₃, δy₃), . . . , (δxₙ, δyₙ) are grid point adjustments to offset the shift of a location in the image frame data from its location in a regular, rectilinear mesh and its location in initial mesh 201. For example, a first set of adjustment values (δx₁, δy₁) accounts for the coordinate shift to perform a camera undistortion and rectification 205 to offset the distortions induced by the shape of the camera lens. A second set of adjustment values (δx₂, δy₂) accounts for the coordinate shift to perform a static passthrough transformation 210 to offset distortions or projection effects from static causes (for example, the positioning of a see-through camera at a point removed from a viewer's eyeball. A third set of adjustment values (δx₃, δy₃) accounts for the coordinate shift to perform a dynamic passthrough transformation 215 to account for coordinate shifts associated with dynamic factors (for example, head pose change compensation). Other adjustment values (δxₙ, δyₙ) account for the coordinate shift to perform display correction including corrections of geometric distortions and chromatic aberrations.

As discussed herein, for sources of distortion which are static (i.e., sources of distortion where the values of (δx, δy) do not change over time or in response to present values of any variable), vertex adjustment values for reprojecting the image data according to a corrected mesh can be determined in advance, and do not need to be subsequently recalculated. Examples of static sources of distortion include focal distortions (for example, barrel or pincushion distortions) of the lens of the see-through camera from which image data is obtained. Other examples of static sources of distortion include parallax, or viewpoint effects arising from differences in the location of the see-through camera (for example, on the exterior perimeter of a wearable XR device) relative to the expected location of a viewer's eye. In this way, embodiments according to the present disclosure reduce the computational load associated with generating a VST XR display.

Although FIG. 2 illustrates one example of distortion meshes and corrected meshes, various changes may be made to the example described with reference to FIG. 2. For example, depending on the character of the lens distortion, initial and distortion meshes 201, 250 may comprise vertices in a polar coordinate system.

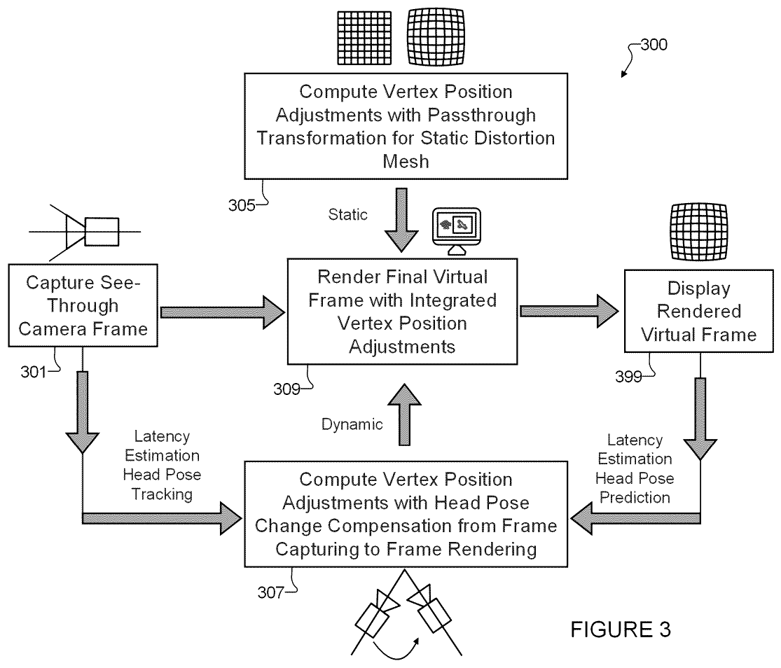

FIG. 3 illustrates an example pipeline 300 for vertex pose adjustment with passthrough and time-warp transformations in VST XR in accordance with this disclosure. For case of explanation, the pipeline 300 of FIG. 3 is described as a set of processes that can be implemented using the electronic device 101 in the network configuration 100 of FIG. 1. However, the pipeline 300 may be implemented using any other suitable device(s) and in any other suitable system(s), such as the server 106, and the pipeline 300 may perform any other suitable process(es).

Referring to the illustrative example of FIG. 3, pipeline 300 comprises a processing architecture by which a frame 301 from a see-through camera is rendered as a virtual frame, and the displayed rendered virtual frame 399 is presented at a time such that the pose-dependent viewpoint of displayed rendered virtual frame 399 corresponds to the predicted pose-dependent viewpoint of a user at the time of display. In this way, embodiments implementing pipeline 300 can eliminate or significantly reduce both rendering latency and discrepancies between the viewpoint of a VST XR display, and the viewpoint a user expects based on their body's sense of proprioception.

At block 305, vertex position adjustments of the static components of a distortion mesh can be computed. Block 305 can be performed prior to capturing see-through camera frame 301, as part of a calibration process performed during startup of the XR device, or, in some embodiments, can be performed as part of an initial configuration during manufacture of the XR device. Vertex adjustments for one or more static components of the distortion mesh may be obtained by capturing image data of a test pattern, checkerboard, or other subject in which the distortions due to static factors can be identified or quantified from the image data.

For example, the vertex adjustments associated with lens distortions of a see-through camera can be determined by first creating a regular grid G_{d} (m,n) for defining a distortion mesh, as shown below:

$$grid = {G}_{d} ( m , n ) , ( m = 0 , 1 , … , M ; n = 0 , 1 , … , N ) \qquad ( 1 )$$

Here, M is the grid width, N is the grid height. The values (m, n) can be normalized to the range [0, 1] to create an identity mesh.

A distortion mesh M_{d}(x,y) for distortion transformation and rendering can be defined as follows:

$$mesh = {M}_{d} ( x , y ) , ( x ∈ [ - 1 , 1 ] ; y ∈ [ - 1 , 1 ] ) \qquad ( 2 )$$

Here, (x, y) is also normalized to the range [−1, 1].

Camera lens distortion D_{c} can be defined as follows:

$${D}_{c} = C ( {x}_{c} , {y}_{c} ) , ( {x}_{c} ∈ [ 0 , 1 ] , {y}_{c} ∈ [ 0 , 1 ] ) \qquad ( 3 )$$

Here, (x_{c}>y_{c}) is normalized to the range [0, 1] for camera lens distortion. The lens distortion can be computed by a lens distortion model from camera calibration, such as calibration based on image data of a test image.

From the above, vertex adjustments for camera lens distortion D_{c} can be computed as follows:

$${d}_{c} = C ( {x}_{c} , {y}_{c} ) - {G}_{d} ( m , n ) \qquad ( 4 )$$

Here, (x_{c}, y_{c}) and (m, n) are normalized to the range [0, 1].

In addition to computing vertex adjustment values for fixed distortions due to the shape of the lens of a see-through camera, vertex adjustment values to match the viewpoint of image data obtained by the see-through camera to that of the user's eye (to offset the fact that the see-through camera cannot occupy the same physical location as the user's eye) can also be performed at block 305. Similar to camera lens distortion D_{c} (described with reference to Equation (3) above), the distortion Dₘ, due to the difference in location between a see-through camera lens and a user's eye can be represented by a transformation, such as shown below:

$${D}_{m} = {V}_{p} ( {x}_{v} , {y}_{v} ) , ( {x}_{v} ∈ [ - 1 , 1 ] ; {y}_{v} ∈ [ - 1 , 1 ] ) \qquad ( 5 )$$

From this vertex adjustment values for viewpoint matching can be computed, such as shown below:

$${d}_{v} = {D}_{m} - {D}_{c} \qquad ( 6 )$$

Chromatic aberrations, such as the blue-yellow or red-green fringes seen along edges between areas of high contrast between light and dark and can be particularly pronounced in image data obtained from cameras with wide-angle or fisheye lenses, present a further example of static distortion for which vertex adjustment values can be obtained at block 305. In some embodiments, generating vertex adjustment values for chromatic aberrations along similar lines to calculating vertex adjustment values due to the overall lens shape. For example, distortion for each channel of the color space used in the image data (for example, RGB or CYMK) can be modeled as follows:

$$\{ \begin{matrix}{D}_{l}^{r} = R ( {x}_{r} , {y}_{r} ) , ( {x}_{r} ∈ [ - 1 , 1 ] ; {y}_{r} ∈ [ - 1 , 1 ] ) \\ {D}_{l}^{g} = G ( {x}_{g} , {y}_{g} ) , ( {x}_{g} ∈ [ - 1 , 1 ] ; {y}_{g} ∈ [ - 1 , 1 ] ) \\ {D}_{l}^{b} = B ( {x}_{b} , {y}_{b} ) , ( {x}_{b} ∈ [ - 1 , 1 ] ; {y}_{b} ∈ [ - 1 , 1 ] )\end{matrix} \qquad ( 7 )$$

Here, R(xᵣ, yᵣ), G(x_{g}, y_{g}), B(x_{b}, y_{b}) are lens distortion models in the individual color channels of the color space, which in this explanatory example, is the red-green-blue (“RGB”) color space.

From the color-channel specific lens distortion models, distortion differences due to chromatic aberrations can be computed as follows:

$$\{ \begin{matrix}{d}_{rg} = R ( {x}_{r} , {y}_{r} ) - G ( {x}_{g} , {y}_{g} ) \\ {d}_{bg} = B ( {x}_{r} , {y}_{r} ) - G ( {x}_{g} , {y}_{g} )\end{matrix} , \qquad ( 8 )$$

Here, G(x_{g}, y_{g}) is the previously-calculated display lens geometric distortion and the differences (d_{rg}, d_{bg}) are due to chromatic aberrations.

By pre-calculating vertex position adjustments for static sources of distortion at block 305 significant processing time savings between capturing see-through camera image frames and displaying a rendered XR frame can be realized. Table 1 below lists observed processing times associated with calculating vertex point adjustments for certain sources of static distortion.

TABLE 1

| | Measured |
|---|---|
| | Processing |
| Operation | Time (ms) |
| Generating Distortion | 5 |
| Mesh | |
| Determining Vertex | 371.842 |
| Adjustment Values for | |
| See-Through Camera Lens | |
| Distortion | |
| Determining Vertex | 0.136 |
| Adjustment Values for | |
| Viewpoint Matching | |
| Determining Vertex | 130.045 |
| Adjustment Values for | |
| Lens Distortion | |
| Display Lens Chromatic | 260.090 |
| Aberration | |

As shown above, the five computing operations shown above collectively require approximately 0.75 seconds to perform, meaning that if performed on a rolling, per frame basis, would introduce significant latency between image capture and display at an XR headset. Pre-computing vertex adjustment values and distortion meshes for these static sources of distortion at block 305 can significantly reduce the latency associated with providing a VST XR display. Even with the time savings associated with the operations performed at block 305, rendering and displaying a VST XR frame generally entails processing performed over human-perceptible time intervals (for example, hundredths of a second), and, by implication, human perceptible latency between the time see-through camera frame 301 is captured and the rendered virtual frame 399 is displayed. In applications where human-perceptible latency between image frame capture and VST XR frame display is present, changes in a user's head pose (rotational, translational or both) during this interval can result in human-perceptible mismatches between the pose-dependent perspective of the displayed rendered virtual frame and the user's proprioception-based understanding of the user's pose at the time of display. As noted in this disclosure, even small mismatches between the pose-dependent perspective of rendered virtual frame 399 and the user's native understanding of the user's pose-dependent perspective can cause nausea, which significantly degrades a user's XR experience.

Referring to the illustrative example of FIG. 3, in cases where the processing associated with rendering virtual frame 399 requires a human-perceptible time interval, the XR experience can be significantly improved by rendering virtual frame 399 from an expected pose-dependent viewpoint of the viewer at the time of display, rather than from the viewpoint of the user's head at the time see-through frame 301 is captured. Accordingly at block 307, the processor (whether in the XR headset itself or an accessory device) estimates the correction interval associated with the operations between capturing see-through camera frame 301 and displaying rendered virtual frame 399. As used in this disclosure, the expression “correction interval” encompasses the period of time (or latency) between image frame capture and XR frame display during which the processing platform corrects the raw image obtained from the see-through camera obtained at a first time for display at a second, subsequent time.

Depending on embodiments, at block 307, the correction interval can be estimated programmatically, for example, by starting with a minimum correction interval, and incrementing the correction interval by predetermined intervals upwards based on one or more rules-based criteria (for example, the number of other applications executing at the processor, available memory, etc.). In some embodiments, the correction interval can be calculated dynamically, as a weighted numerical function of one or more present values (for example, available memory, quantity of virtual content to be rendered as part of the XR) describing the available processing resources and expected size of the instant processing task.

Once a correction interval has been estimated, at block 307, the processor can also estimate a change in the user's head pose during the correction interval, and from this, predict the user's pose-dependent viewpoint at the end of the correction interval. Based on the user's predicted pose-dependent viewpoint, a second set of vertex position adjustments to further correct the image data of see-through camera frame 301 to account for the change in the user's pose-dependent viewpoint over the correction interval.

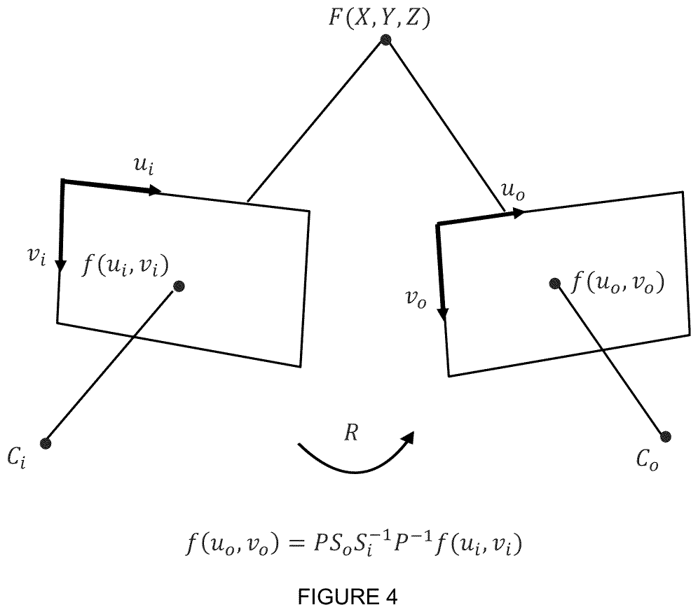

As described in greater detail with reference to FIG. 4 of this disclosure, depending on the data regarding the scene and the user's head available to the processing device(s) implementing the XR display, the user's predicted pose-dependent viewpoint at the end of the correction interval can be computed according to a variety of methods. In some embodiments, the user's predicted pose-dependent viewpoint may be based upon a time-warp projection accounting only for rotational movement during the correction interval. In some embodiments, including embodiments where data capturing the user's translational movement (for example, depth data, or motion sensor data) is available, the predicted pose-dependent viewpoint may also account for translational movement.

At block 309, the processing platform integrates or “puts together” the first set of vertex position adjustment values obtained at block 305 and the second set of vertex position values obtained at block 307 to create a distortion mesh for correcting both the static sources of distortion, as well as the dynamic sources of differences between see-through camera frame 301 and rendered virtual frame 399 (for example, the user's predicted pose-dependent viewpoint). Depending on the extent of the static distortions corrected at block 305, and the extent and nature of it can be computationally advantageous to apply the first set of vertex adjustment values to obtain intermediate image data, wherein in the intermediate image data is corrected for static sources of distortion, prior to applying the second set of vertex adjustment values to account for dynamic changes, such as predicted changes in the user's pose-dependent viewpoint. For example, when performed on heavily distorted image data (such as obtained from a fisheye lens) certain perspective corrections, such as time-warp reprojection to account for changes in perspective, are harder to perform correctly on uncorrected image data.

In addition to applying the first and second sets of vertex adjustment values of the distortion mesh, at block 309, the processing device renders a final virtual frame. Rendering a final virtual frame can include, without limitation, rendering and positioning items of virtual content within the final virtual frame. As used in this disclosure, the expression “item of visual content” encompasses objects appearing in an XR display, and which are not present in the physical world captured by the see-through camera. Examples of items of visual content include, without limitation, text or characters appearing to sit on surfaces of real-world objects, and avatar reprojections (for example, reprojections of recognized faces in the scene as cartoon characters) of real-world people and objects.

Once rendered, virtual frame 399 is displayed at the display of the XR device at a second time corresponding to the end of the correction interval.

Although FIG. 3 illustrates one example of a pipeline 300 for vertex pose adjustment with passthrough and time-warp transformations in VST XR, various changes may be made to FIG. 3. For example, various components or functions in FIG. 3 may be combined, further subdivided, replicated, omitted, or rearranged and additional components or functions may be added according to particular needs. As a particular example of this, in some embodiments, generating intermediate image data by separately applying the first set of vertex position adjustments prior to applying the second set of vertex position adjustments may be omitted.

FIG. 4 illustrates aspects of generating vertex position adjustments for a pose-dependent viewpoint according to various embodiments of this disclosure. Specifically, FIG. 4 describes an example of computing vertex adjustment values to compensate for head movements over a correction interval (for example, as performed at block 307 in FIG. 3).

Referring to the explanatory example of FIG. 4, at a fundamental level, compensating for head movements over a correction interval requires creating a new image frame f(uₒ, vₒ) at a new pose Sₒ from an existing frame f(uᵢ, vᵢ) at an existing pose Sᵢ, wherein the existing frame is based on image data obtained from a see-through camera (for example, see-through camera frame 301) at a first time, and the new image frame is a reprojection based on the user's predicted pose at a second time at the end of the correction interval.

As shown in FIG. 4, first frame f(uᵢ, vᵢ) is captured from a first perspective Cᵢ and the new image frame f(uₒ, vₒ) comprises a reprojection of f(uᵢ, vᵢ) at the second time, wherein the user's pose is predicted to have changed based on a rotation R over the correction interval, such that new image frame f(uₒ, vₒ) is displayed from the predicted new perspective Cₒ. The reprojection of f(uᵢ, vᵢ) as new image frame f(uₒ, vₒ) can be performed by a transform of the form:

$$f ( {u}_{o} , {v}_{o} ) = P {S}_{o} {S}_{i}^{- 1} {P}^{- 1} f ( {u}_{i} , {v}_{i} ) \qquad ( 9 )$$

Here, P is a projection matrix, Sₒ, is a predicted head pose, and Sᵢ is a head pose while capturing frame f(uᵢ, vᵢ).

Depending on the data available to the processing device implementing vertex position adjustment for pass-through VST, Sₒ can be obtained in one of a plurality of ways, using simultaneous location and mapping (“SLAM”) techniques for predicting the user's pose at the end of the correction interval. For example, where depth information of the scene captured by the see-through image data is not available, the user's predicted pose Sₒ can be predicted based on a time-warp transformation based on data as to the magnitude and direction of the user's head rotation. Data on the magnitude and direction of a user's head rotation can be obtained in multiple ways, including, without limitation, from sensor data (i.e., data from a 3 DOF or 6 DOF accelerometer), or based on frame-over-frame changes in frames obtained prior to frame f(uᵢ, vᵢ).

In certain embodiments, such as where depth information is not available, or performing calculations using depth information may introduce unwanted latency, Sₒ can be determined only based on a predicted rotation of a user's head during the compensation interval, with translational changes expressed through depth information removed from the pose prediction. In such cases, Equation 9 can be simplified as:

$$f ( {u}_{o} , {v}_{o} ) = {T}_{w} f ( {u}_{i} , {v}_{i} ) \qquad ( 10 )$$

Here, is T_{w} is a depth-independent time-warp transformation accounting for only rotational changes in the user's pose.

T_{w} can be further expressed as:

$${T}_{w} = {PS}_{o} {S}_{i}^{- 1} {P}^{- 1} \qquad ( 11 )$$

Here, Sₒ and Sᵢ are expressions of head pose which only capture the rotational position of the user's head at the start and end of the correction interval.

From the time-warp transformation Tw, vertex adjustment values can be computed to account for the shift in viewpoint over the correction interval, as shown below:

$${d}_{v}^{t} = {T}_{w} {d}_{ν} = {T}_{w} ( {D}_{m} ( {x}_{ν} , {y}_{v} ) - {D}_{c} ( {x}_{c} , {y}_{c} ) ) \qquad ( 12 )$$

As noted previously, vertex position adjustments can be applied in either multiple passes (for example, by applying corrections for static sources of distortion in a first pass, and then further correcting to account for pose changes during a compensation interval in a second pass), or in a single pass.

Regardless of whether the vertex position adjustments are applied in a single or multiple passes, each vertex (x_{d}, y_{d}) of a final distortion mesh can be expressed as a value (x,y) of an initial distortion mesh plus the sum of vertex adjustment values for each of the compensated static and dynamic sources of distortion, as shown below:

$$( {x}_{d} , {y}_{d} ) = ( x , y ) + ( δ {x}_{1} , δ {y}_{1} ) + ( δ {x}_{2} , δ {y}_{2} ) + ( δ {x}_{3} , δ {y}_{3} ) + … \qquad ( 13 )$$

Although FIG. 3 illustrates one example of predicting a head pose at the end of a correction interval and generating vertex position adjustments for the predicted head pose at the end of a correction interval as part of a rendering pipeline of a VST AR display, various changes may be made to FIG. 3. For example, various components or functions in FIG. 3 may be combined, further subdivided, replicated, omitted, or rearranged and additional components or functions may be added according to particular needs. As a particular example of this, where depth information is available, the time-warp reprojection to determine the vertex adjustments associated with the change in the user's pose-dependent viewpoint can be expanded to account for both rotational and translational movement of the user's head. Specifically, the frame-over-frame change over the correction interval can be represented as:

$$f ( {u}_{o} , {v}_{o} , {d}_{o} ) = {PS}_{o} {S}_{i}^{- 1} f ( {u}_{i} , {v}_{i} , {d}_{i} ) \qquad ( 14 )$$

Here, the existing frame f(uᵢ, vᵢ, dᵢ) and the new frame f(uₒ, vₒ, dₒ) express coordinates in a three-dimensional space and poses Sᵢ and Sₒ include head rotation and translation.

Subsequent to implementing vertex corrections for the predicted pose change over the correction interval, a depth-based reprojection of the objects in the see-through camera image frame is computed, for example, by a vertex shader or fragment shader, to account for occlusion and changes in the relative size of objects in the image frame. Further examples of depth-based reprojection of image data may be found in United States Patent Publication No. 2023/0245396, which is incorporated herein by reference.

In a further example of additional ways in which certain embodiments according to this disclosure can account for the changes in pose during a compensation interval, is that, in embodiments in which depth information is available, depth based reprojection and VST pass-through correction can be handled in a single pass by one or more processing modules responsible for depth-based reprojection of image data, such as by a vertex shader or a fragment shader.

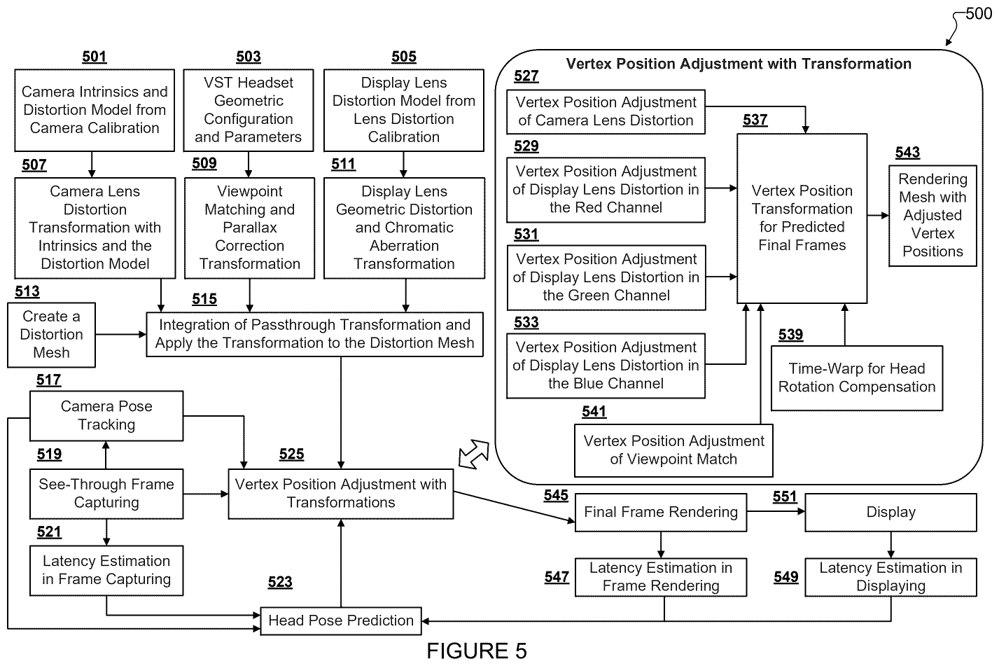

FIG. 5 illustrates an example pipeline 500 for vertex pose adjustment with passthrough and time-warp transformations in VST XR in accordance with this disclosure. For case of explanation, the pipeline 500 of FIG. 5 is described as a set of processes that can be implemented using the electronic device 101 in the network configuration 100 of FIG. 1. However, the pipeline 500 may be implemented using any other suitable device(s) and in any other suitable system(s), such as the server 106, and the pipeline 500 may perform any other suitable processes.

Referring to the illustrative example of FIG. 5, blocks 501-515 comprise the constituent processes of generating a passthrough transformation. Specifically, blocks 501-515 comprise generating a distortion mesh and determining a first set of vertex adjustment values to compensate for static sources of distortion in image frame data obtained from a sec-through camera of an XR device. In some embodiments, the operations described with reference to blocks 501-515 can be performed before starting to obtain see-through camera image frame data. For example, blocks 501-515 can be performed by a processing device as part of an initialization routine of an XR device.

At block 501, a distortion model for the see-through camera is determined. In some embodiments, determining the distortion model comprises obtaining image data from the see-through camera of a ground truth image (such as a test pattern or checkerboard shown in FIG. 2) from which the geometric distortions (for example, barrel or pincushion distortions) inherent to the shape of the lens of the see-through camera can be determined and expressed in a quantitative model, such as a radial distortion model.

At block 503, a model for the geometric relationship between the location see-through camera of the XR device providing the image frame data for the VST XR display and the expected location of the viewer's eye is determined. Given that a see-through camera cannot occupy the same location as the viewer's eye, and that there are analytical benefits (for example, improved parallax-based depth estimation) to spacing the one or more see-through cameras further apart than the natural spread of human eyes, the spatial relationship between the perspective of the see-through camera(s) and the viewer's eyes needs to be modeled and compensated for.

At block 505, a model for the lens characteristics other than the intrinsic distortions due to the lens shapes is generated. For example, the differences in refraction across light wavelengths which give rise to chromatic aberrations and other color-specific distortions may be quantified and modeled at block 505.

At block 507, a transform of the model for the intrinsic distortion due to the shape of the see-through camera's lens is determined. According to some embodiments, the model underlying the transform may be of the same general form as the distortion model described with reference to Equation (3) of this disclosure.

According to certain embodiments, at block 509, a transform of the model for viewpoint matching between the see-through camera and the user's eye is determined. The transform for viewpoint correction and parallax issues arising from differences in lens spread between two or more see-through cameras and the spread of a user's eyes can be of the same general form as the transformation described with reference to Equation (5) of this disclosure.

At block 511, a transform to account for further, color-specific distortions (such as chromatic aberrations) is determined based on the model generated at block 505. The transforms for color fringing-type chromatic aberration can be of the same general form as those described with reference to Equations (7)-(8) of this disclosure.

At block 513, a distortion mesh (for example, distortion mesh 203) embodying the distortions modeled at blocks 501, 503, and 505 is created. At block 515, vertex adjustment values for each of the transformations performed at blocks 507-511 are generated and applied to the distortion mesh generated at block 513. In some embodiments, the operations performed at block 515 parallel the corrections described with reference to FIG. 2 to generate corrected mesh 205 from distortion mesh 203.

To reduce latency in generating VST XR frames from see-through camera image frames, corrections for static sources of distortion in the passthrough image data can be corrected in advance, and vertex adjustment values pre-calculated for rapid application to image frames from a see-through camera. As discussed with reference to Table 1 of this disclosure, by performing blocks 501-515 in advance, rather on a rolling frame-by-frame basis, the latency associated with providing an XR display from see-through camera image data can be reduced by up to ¾ of a second.

At block 517, the processing device implementing pipeline 500 performs camera pose tracking. Depending on the sensors provided at the XR device worn by the user, camera pose tracking can be implemented in a variety of ways. For example, where the XR device includes motion sensors (for example, 3 DOF or 6 DOF accelerometers) and/or depth sensors (for example, time of flight (“TOF”) sensors), the camera pose tracking performed at block 517 may comprise an implementation of a full-featured SLAM pipeline. Additionally, or alternatively, where, for example, the XR device does not include motion and/or depth sensors, or conserving processing resources is a priority, camera pose tracking at block 517 can be performed by performing a frame-over-frame analysis to estimate rate and direction of changes in a user's pose.

At block 519, the processing platform providing the VST XR display obtains one or more frames of image data from one or more see-through cameras of the XR device, wherein the one or more frames of image data are obtained at a first time. Depending on the configuration of the XR device and the see-through camera(s) provided thereon, block 517 can comprise receiving the direct (or straight-out-of-camera (“SOOC”)) output of a CMOS sensor or the like. In some embodiments, capturing a see-through frame may comprise capturing a plurality of frames obtained at the same time by a see-through camera, wherein each of the plurality of frames corresponds to a channel of a color space of the see-through camera. In the illustrative example of FIG. 5, the see-through camera provides an output in the red-green-blue color space, and at block 519, the processing device capture an image frame in the red channel, a frame in the green channel and an image frame in the blue channel at a first time. Additionally, in embodiments in which an XR device is provided with multiple see-through cameras (for example, to widen a field of view or as a source of stereoscopic depth data), the data obtained at block 517 may be pre-processed (for example, to fuse the outputs of two cameras).

As noted elsewhere herein, the technical benefits provided by certain embodiments according to this disclosure include improved synchronization between the perspective of the VST XR display and the user's native understanding of the user's pose-dependent perspective. Synchronizing the perspective of a future XR display with a user's future pose-dependent perspective generally requires that the processing device know the future time which the XR display is to be presented. For many applications, the primary sources of at least some unavoidable latency between frame capture at block 519 and display of a rendered XR frame at block 551 include latency capturing the image (for example, due to the time associated with exposing the sensor, and buffering and outputting the data from the sensor as an image frame), latency in rendering the frame (for example, latency associated with depth-based reprojection and generating and positioning items of virtual content within an XR frame) and latency in displaying the XR frame (for example, where the XR frame is one of a plurality of items of content to be placed on the display).

Accordingly, at block 521, the processing platform can estimate the latency associated with the capture of a see-through image frame at block 519. Depending on embodiments, estimating the latency for capturing an image frame can be done programmatically (for example, by applying tabulated values for present constraints, such as the selected resolution of the image frame) or calculated dynamically.

Similarly, at block 547, the latency associated with rendering an XR frame for display is estimated. As with estimating the latency for capturing an image frame, depending on embodiments and available resources, this can be performed either programmatically or dynamically calculated.

Likewise, at block 549, the latency associated with displaying a rendered XR frame at an XR device is estimated. This, too can be performed programmatically or analytically, depending on the design goals and processing resources of the specific implementation.

In the explanatory example of FIG. 5, the outputs of blocks 521, 547, and 549 are summed to generate an estimated correction interval (i.e., an estimate of the total interval between capture of a see-through frame at block 519 and display of an XR frame at block 551). From the correction interval, the processing device implementing pipeline 500 has a target time for performing a head pose prediction. At block 523, the processing device implementing pipeline 500 applies the camera pose tracking information obtained at block 517 to generate a prediction of the XR device wearer's head pose at a second time at the end of the correction interval. Predicting the user's head pose at block 523 can be performed according to one or more techniques known in the art, such as extrapolation from accelerometer data obtained previous to, and/or simultaneously with capturing a see-through image frame at block 519. Additionally, or alternatively, predicting the user's head pose at the second time can be performed using machine learning or artificial intelligence-based approaches, which recognize movement patterns in the camera pose tracking data obtained at block 517.

Referring to the explanatory example of FIG. 5, at block 525, the processing device performs vertex position adjustment for the static sources of distortion, as well as a transformation of the see through frame captured at block 519 to pose-dependent user viewpoint predicted at block 523 to obtain a corrected mesh (for example, corrected mesh 205) which can be used in rendering the XR frame for display.

It will be understood that that integrating the passthrough corrections performed at blocks 501-515 with further corrections to compensate for the movement of the XR device wearer's head during the compensation interval can be performed according to a diverse plurality of operations. Put differently, there are multiple ways of incorporating the corrections for static distortions and predictions about the change in the user's pose over the compensation interval. Blocks 527-543 of FIG. 5 are intended to be illustrative, rather than limitative of how vertex position adjustment with a pose transformation can be performed to achieve the result of block 525.

At block 537, the processing device applies vertex position adjustments for both the static sources of distortion, and the change in pose-dependent viewpoint over the correction interval (shown in FIG. 5 as blocks 527-533 and 539-541). It will be understood that, depending on the implementation, the corrections performed at blocks 527-533 and 539-541 can be performed in different sequences, and can, where appropriate, be batched. For example, in some embodiments, it can be advantageous to apply vertex position adjustments to correct for static sources of distortion in a first batch, thereby obtaining intermediate image data, from which the lens and viewpoint disparities between the user's eye and the see-through camera have been corrected, but which has not yet been corrected to account for changes in pose-dependent viewpoint over the correction interval.

At block 527, the processing device applies the vertex adjustment values to correct for the intrinsic distortion due the shape of the see-through lens and (obtained via blocks 501, 507, and 515) to each channel of the frame data obtained at block 519. In this example, because the image data of the see-through frame is provided as data in each of the channels of an RGB color space, vertex adjustment values for color-specific sources of distortion (due to wavelength-dependent differences in refraction through the lens of the see-through camera) are applied separately based on one or more predetermined models (for example, the model(s) determined at block 505). Thus, at block 529, vertex position adjustment values for color-specific distortions in the red channel are applied to the red channel image data. Similarly, at block 531, vertex position adjustment values for color-specific distortions in the green channel are applied to the green channel image data. At block 533, vertex position adjustment values for color-specific distortions in the blue channel are applied to the blue channel image data.

At block 541, vertex position adjustment values based on the model determined at block 503 for viewpoint correction are applied to the image data. In contrast to the vertex position adjustment values applied at blocks 529-533, the vertex position adjustment values applied at block 541 can be color-independent and applied identically across each of the color channels.

At block 541, the processing device applies vertex position adjustment values (for example, values calculated based on the model generated at block 503) to correct for the viewpoint disparity between an XR device user's eye(s) and the see-through camera(s). Here again, the vertex position adjustment values are color independent, and can be applied either separately or batched to each channel of the image frame data.

At block 539, the processing device applies a transformation to account, based on the head pose prediction obtained at block 523, for the user's pose-dependent viewpoint at the end of the correction interval, and applies vertex adjustment values based on the transformation, such as described with respect to Equations (9)-(12) of this disclosure. In the illustrative example of FIG. 5, the transformation underlying the vertex adjustment values is a time-warp to compensate only for head rotation during the compensation interval.

At block 543, the vertex correction values applied at block 537 are consolidated and re-expressed as a corrected mesh (for example, corrected mesh 205 in FIG. 2) to be used during rendering of the XR frame for display.

At block 545, a VST XR frame based on the image data obtained at block 519 is rendered by the processing device, such as a GPU. Rendering the VST XR frame can include reprojecting the image data obtained at block 519 according to the corrected mesh generated at block 543. Depending on the availability of depth information, at block 545, a depth-based reprojection of the image data, to account for resizing of objects as a result of the user's change in pose-dependent viewpoint can also be performed. Additionally, at block 545, one or more items of virtual content to be included in the XR display is rendered, scaled, and positioned in the VST XR frame. At block 551, the rendered VST XR frame is displayed to the user at the XR device at a second time estimated by the correction interval.

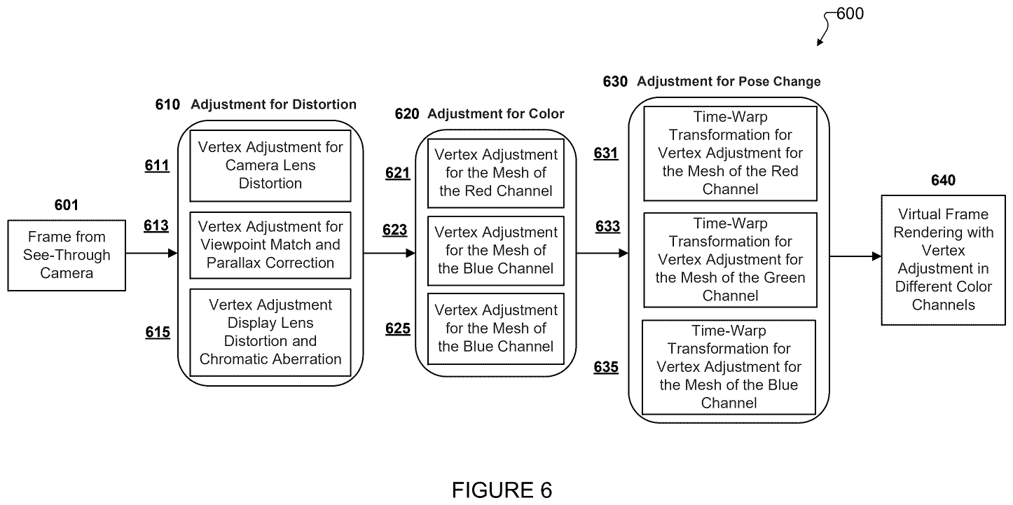

Although FIG. 5 illustrates an example pipeline 500 for vertex pose adjustment with passthrough and time-warp transformations in VST XR, other embodiments or variations are possible and within the contemplated scope of this disclosure. For instance, FIG. 6 describes another example embodiment of such a pipeline. Additionally, in some embodiments, the processing device implementing pipeline 500 displays the VST XR frame at a second time scheduled by the correction interval, that is, the estimated correction interval schedules the display of the VST XR frame, and if the frame is not ready by the specified time, it can be dropped. In some embodiments, the correction interval is used only as an estimation tool, and the VST XR frame is displayed when ready. Depending on the application, variations in frame rate may detract less from the XR experience than dropped frames, or vice versa.

FIG. 6 illustrates an example pipeline 600 for vertex pose adjustment with passthrough and time-warp transformations in VST XR in accordance with this disclosure. For case of explanation, the pipeline 600 of FIG. 6 is described as a set of processes that can be implemented using the electronic device 101 in the network configuration 100 of FIG. 1. However, the pipeline 600 may be implemented using any other suitable device(s) and in any other suitable system(s), and the pipeline 600 may perform any other suitable processes.

As noted elsewhere in this disclosure, this disclosure contemplates multiple processing architectures for generating vertex adjustment values to conform image data obtained from a see-through camera at a first time and mapped to a distortion mesh to a corrected mesh associated with a predicted pose-dependent viewpoint at a second time. Example pipeline 600 is for illustration and should not be construed as limitative of this disclosure or the claims.

Referring to the explanatory example of FIG. 6, at block 601, the processing device (for example, a CPU or GPU provided at an XR device) obtains at a first time, a frame of image data from one or more see-through cameras of the XR device presenting a VST XR display. In this example, the see-through camera frame comprises image data in each of the three channels of the red-green-blue color space. It will be understood that other implementations with different numbers of channels and different color spaces, such as cyan-magenta-yellow-key (“CMYK”) are possible and within the contemplated scope of this disclosure.

In the illustrative example of FIG. 6, vertex adjustment values are applied in parallel, across three initial distortion meshes (one for each channel of the color space) to obtain three corrected meshes for rendering a VST XR frame. In addition to parallel application of vertex adjustment values, correction for static sources of distortion and pose changes over a predicted correction interval, pipeline 600 splits the application of vertex corrections into three discrete stages.

At a first stage 610, the processing device implementing pipeline 600 applies three sets of across-the-board vertex adjustment values for static sources of distortion. In this example, because three separate distortion meshes are created for each of the three color channels of the image data, corrective vertex adjustment values are applied separately to each of the distortion meshes.

For example, at block 611, the processing device applies vertex adjustment values to correct for distortions (for example, barrel, fisheye or moustache distortion) inherent to shape of the lens of the see-through camera from which the image frame data was obtained. As the distortions due to lens shape (excluding wavelength-dependent variations in refraction), are the same across all color channels, a single set of vertex adjustment values can be computed and applied across to each channel of the color space of the see-through camera image data. According to some embodiments, the corrections performed at block 611 can be performed based on the model generated at block 501 of FIG. 5.

Referring to the illustrative example of FIG. 6, at block 613, the processing device applies to each of the three distortion meshes, vertex adjustment values to correct for the viewpoint difference between the viewpoint of the see-through camera and the viewpoint of an XR device user's eye(s) are applied to each of the color channel distortion meshes. As with vertex adjustment values for distortions due to lens shape, the vertex adjustments for correcting the viewpoint mismatch between the see-through camera and the viewer's eye(s) are color-independent and can be computed once and a single result applied across all of the color channels. In some embodiments, the viewpoint adjustment values are determined based on the model determined at block 503 of FIG. 5.

At block 615, vertex adjustment values to correct for chromatic aberrations (for example, multi-color fringes around high-contrast edges are applied to the distortion meshes of each of the constituent color channels of the image data. The aforementioned vertex adjustment values can be determined based on the distortion model of block 505 of FIG. 5.

As shown in FIG. 6, subsequent to applying vertex correction values to the red, green, and blue distortion meshes to account for static sources of distortion, a second batch of vertex adjustments for color-specific sources of distortion is performed at block 620. For example, the color-specific distortion of each color channel can be computed from the lens distortion models in Equation (7). Further, and as described with reference to in Equation (8), distortion differences between channels of the color space (for example, red and green channels and blue and green channels) can be used to determine vertex adjustment values for chromatic aberration corrections. Because the refractive properties of the lens of a see-through camera can vary due to the wavelength of light passing through the lens, further, color-specific refinements to the across-the-board corrections of block 611 may be required. For example, all other factors being equal, the wider the angle of the lens, the more pronounced color-specific distortions can become.

Thus, at block 621, the processing device applies vertex adjustment values to account for wavelength specific distortion to the distortion mesh for the red channel. At block 623, the processing device applies vertex adjustment values to correct for wavelength specific diction to the distortion mesh for the green channel. Similarly, at block 625, the processing device applies color-specific corrections to the distortion mesh for the blue channel.

To further illustrate the variety in which the correction operations for removing static sources of distortion from image data obtained from a see-through camera and updating the pose-dependent viewpoint of an image frame can be batched, sequenced and performed, at a third stage 630, time warp transformations to obtain vertex adjustment values for updating the pose-dependent perspective to correspond to a user's predicted pose-dependent perspective at the end of a correction interval, are performed in parallel on each color channel's distortion mesh.

Thus, in the illustrative example of FIG. 6, at block 631, vertex adjustment values of a time warp transformation (for example, the time warp performed at block 539 of FIG. 5) are applied to the distortion mesh of the red channel of the see-through camera image frame. From this, a final, corrected mesh for rendering the red channel of an VST XR frame is obtained.

Similarly, at block 633, vertex adjustment values of the same time-warp transformations are applied to the distortion mesh of the green channel of the see-through camera image frame. The distortion mesh of blue channel of the see-through camera image frame is likewise adjusted at block 635. From blocks 633 and 635, final, corrected meshes for rendering the blue and green channels of the VST XR frame are obtained. At block 640, a VST XR frame comprising data in each of the three color channels is rendered based on the corrected distortion meshes obtained at blocks 631, 633, and 635.

Although FIG. 6 illustrates an example pipeline 600 for vertex pose adjustment with passthrough and time-warp transformations in VST XR, other embodiments or variations are possible and within the contemplated scope of this disclosure. For example, the vertex adjustment values for chromatic aberration could, instead of being performed as part of the first batch of corrections performed at first stage 610, be performed as part of the individual color channel corrections performed in the second stage, shown as block 620.

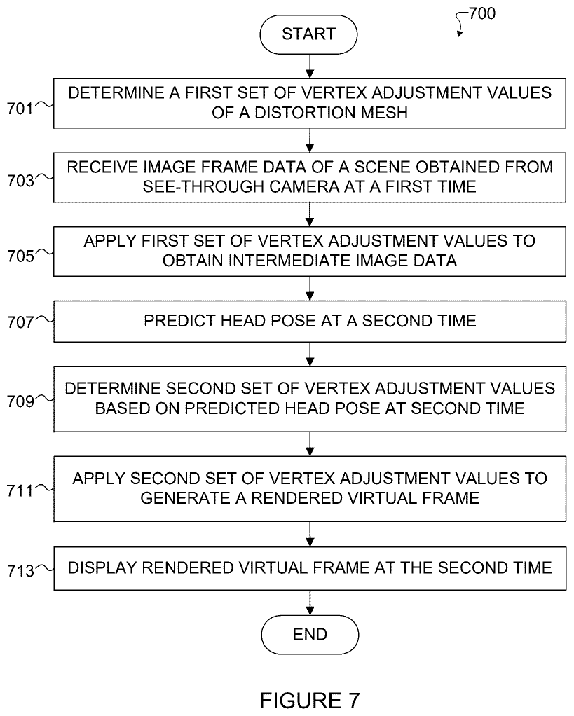

FIG. 7 illustrates an example method 700 for vertex pose adjustment with passthrough and time-warp transformation in VST XR. For case of explanation, the method 700 of FIG. 7 is described as a set of processes that can be implemented using the electronic device 101 in the network configuration 100 of FIG. 1. However, method 700 may be implemented using any other suitable device(s), such as the server 106, and in any other suitable system(s).

As shown in FIG. 7, at step 701, a processing device (for example, processor 120) in FIG. 1 generates a distortion map (for example, distortion mesh 203 in FIG. 2), wherein the distortion map comprises vertices defining coordinates within image data at locations that, due to intrinsic, static properties of a see-through camera of an XR device, are distorted, and shifted from desired locations in a VST XR display. Examples of such intrinsic or static sources of distortion include, without limitation, distortions due to the shape of the lens of the see-through camera from which image data is obtained, and viewpoint disparities arising from the separation between an XR device user's eye(s) and the see-through camera. At step 701, a first set of vertex adjustment values, which define coordinate shifts for the vertices of the distortion map to correct for one or more sources of static or intrinsic distortion are generated—for example, as described with reference to equations (1)-(8) of this disclosure. To reduce latency, step 701 can be performed as part of a calibration or initialization routine for the XR device, with the first set of vertex adjustment values stored in a memory for ready access.

At step 703, the processing device providing the VST XR display receives image frame data from the see-through camera, wherein the image frame data is captured at a first time associated with a first head pose of a user wearing the XR device. Depending on embodiments, the image frame received at step 703 may be received as a straight out of camera (“SOOC”).RAW file. In some embodiments, the image frame may be provided in discrete sets of data corresponding to the component color channels of the color space used by the sec-through camera. Additionally, in some embodiments, the image data received at step 703 can just be image data of a first camera of a stereoscopic pair of see-through cameras, wherein two instances of method 700 are performed in parallel.

At step 705, the processing device applies a distortion mesh which has been corrected by the first set of vertex adjustment values to obtain intermediate image data which has been corrected for intrinsic and static sources of distortion. Depending on the format of the image frame data received at 703, step 705 can comprise multiple applications of the first of vertex adjustment values. For example, where the image data is provided as multiple individual and discrete sets of image data corresponding to each of a plurality of color channels, vertex adjustment values may have to be applied to each set of image data.

At step 707, the processing device predicts the head pose of the user at a second time, wherein the second time is subsequent to the first time. The second time can correspond to the estimated time of conclusion of a correction interval. In some embodiments, the duration of the correction interval can be determined by estimating the time to clear one or more major processing bottlenecks (for example, receiving image data from the see-through camera, rendering a frame of XR content based on the image data, and/or displaying the rendered frame to the user). Depending on the application, available data, and processing resources, determining the second time can be performed programmatically or dynamically calculated.

Similarly, depending on, without limitation, the available data regarding the user's head pose at the first time, the sensors available at the XR device, and the current processing load at the processing device, the user's head can be predicted according to one or more of the following methods: extrapolation from sensor data indicating the direction and magnitude of the change in the user's pose at the first time or by machine learning techniques identifying a predicted movement based on sensor data, frame-over-frame changes in the image data or combinations thereof. Predicting the user's head pose can, in some embodiments, be limited to predicting a rotational change in the user's pose (for example, as described with reference to block 539 of FIG. 5). Additionally or alternatively, predicting the user's head pose at the second time can include a prediction of translational changes in the user's pose based on one or more of acceleration sensor (for example, a 6DOF accelerometer) data or depth data (for example, depth data obtained from a TOF depth sensor).

At step 709, a second set of vertex adjustment values, based on the predicted second head pose are generated. In some embodiments, the second set of vertex adjustment values can be generated according to the transformation described with reference to Equations (9)-(13) of this disclosure.

At step 711, the second set of vertex adjustment values are applied (for example, as described with reference to block 545 of FIG. 5 and block 640 of FIG. 6) as part of a rendering operation to generate a virtual frame for display to the user. The rendered virtual frame comprises visual content based on the see-through camera frame received at step 703, and which has been corrected for one or more static or intrinsic distortions created by the see-through-camera, and reprojected from the pose-dependent viewpoint at the first time, to a second pose-dependent viewpoint based on the prediction of the user's head pose performed at step 707. At step 711, the processing device can also make further changes to the corrected image data, such as adding items of virtual content into the display.

At step 713, the processing device causes the XR device to display the rendered virtual frame at the second time. By predicting the head pose of the user at step 707, disparities between the pose-dependent viewpoint of the XR display provided at step 713 and the user's native, proprioception-based understanding of the user's pose and viewpoint are minimized, resulting in an improved, less motion sickness-inducing XR experience.

Although FIG. 7 illustrates one example method for vertex pose adjustment with passthrough and time-warp transformations in VST XR, various changes may be made to FIG. 7. For example, while shown as a series of steps, various steps in FIG. 7 could overlap, occur in parallel, occur in a different order, or occur any number of times (including zero times). Depending on the specific requirements (for example, prioritizing maintaining a steady frame rate) of the implementation, as well as the sensor data and processing capacity of the processing device, operations of method 700 can be sequenced differently or merged. As one specific example, where depth information and translational movement is available, and the processing device(s) include a GPU, applying the first and second sets of vertex adjustment values may be combined in a single step performed as part of a depth-based reprojection performed by a vertex shader of the GPU. In such embodiments, the creation and use of intermediate data, as described with reference to step 705, may be eliminated.

It should be noted that the functions shown in or described with respect to FIGS. 2 through 7 can be implemented in an electronic device 101, 102, 104, server 106, or other device(s) in any suitable manner. For example, at least some of the functions shown in or described with respect to FIGS. 2 through 7 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 7 can be implemented or supported using dedicated hardware components. In general, the functions shown in or described with respect to FIGS. 2 through 7 can be performed using any suitable hardware or any suitable combination of hardware and software/firmware instructions. Also, the functions shown in or described with respect to FIGS. 2 through 7 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
determining, using at least one processing device of an extended reality (XR) device, a first set of vertex adjustment values of a distortion mesh;
receiving, using the at least one processing device, image frame data of a scene captured at a first time and at a first head pose using a see-through camera of the XR device;
applying, using the at least one processing device, the first set of vertex adjustment values of the distortion mesh to the image frame data to obtain intermediate image data;
predicting, using the at least one processing device, a second head pose at a second time subsequent to the first time;
generating, using the at least one processing device, based on the predicted second head pose, a second set of vertex adjustment values of the distortion mesh;
applying, using the at least one processing device, the second set of vertex adjustment values of the distortion mesh to the intermediate image data to generate a rendered virtual frame; and
displaying the rendered virtual frame by the XR device at the second time, the rendered virtual frame comprising a corrected view of the scene.

2. The method of claim 1, wherein:
the first set of vertex adjustment values compensates for static differences between the image frame data and the corrected view of the scene; and
the static differences comprise at least one of: a distortion due to a lens of the see-through camera, a chromatic aberration due to the lens of the see-through camera, or a viewpoint difference due to a separation between a location of the see-through camera and a location of a user's eye.

3. The method of claim 1, wherein the second head pose comprises a time-warp transformation of the first head pose.

4. The method of claim 1, further comprising:
obtaining depth data of the scene captured by a depth sensor of the XR device at the first time;
obtaining motion data captured by a motion sensor of the XR device at the first time; and
predicting the second head pose based on the depth data and the motion data,
wherein the second head pose comprises a prediction of a rotational position and a translational position of the XR device at the second time.

5. The method of claim 4, wherein predicting the second head pose comprises performing a depth-based reprojection to predict the translational position of the XR device at the second time.

6. The method of claim 1, wherein applying the first set of vertex adjustment values of the distortion mesh and applying the second set of vertex adjustment values of the distortion mesh are performed by at least one of: a vertex shader or a fragment shader.

7. The method of claim 1, further comprising:
estimating a correction interval comprising at least one of: an estimated latency interval for predicting the second head pose, an estimated latency interval for generating the rendered virtual frame, or an estimated latency interval for displaying the rendered virtual frame; and
determining the second time based on the correction interval.

8. An extended reality (XR) device comprising:
at least one display;
a see-through camera; and
at least one processing device configured to:
determine a first set of vertex adjustment values of a distortion mesh;
receive image frame data of a scene captured at a first time and at a first head pose by the see-through camera;
apply the first set of vertex adjustment values of the distortion mesh to the image frame data to obtain intermediate image data;
predict, a second head pose at a second time subsequent to the first time;
generate, based on the predicted second head pose, a second set of vertex adjustment values of the distortion mesh;
apply the second set of vertex adjustment values of the distortion mesh to the intermediate image data to generate a rendered virtual frame; and
display at the at least one display, the rendered virtual frame by the XR device at the second time, the rendered virtual frame comprising a corrected view of the scene.

9. The XR device of claim 8, wherein:
the first set of vertex adjustment values compensates for static differences between the image frame data and the corrected view of the scene; and
the static differences comprise at least one of: a distortion due to a lens of the see-through camera, a chromatic aberration due to the lens of the see-through camera, or a viewpoint difference due to a separation between a location of the see-through camera and a location of a user's eye.

10. The XR device of claim 8, wherein the second head pose comprises a time-warp transformation of the first head pose.

11. The XR device of claim 8, further comprising:
a depth sensor; and
a motion sensor,
wherein the at least one processing device is further configured to:
obtain depth data of the scene captured by the depth sensor at the first time;
obtain motion data captured by the motion sensor at the first time; and
predict the second head pose based on the depth data and the motion data,
wherein the second head pose comprises a prediction of a rotational position and a translational position of the XR device at the second time.

12. The XR device of claim 11, wherein the at least one processing device is configured to predict the second head pose by performing a depth-based reprojection to predict the translational position of the XR device at the second time.

13. The XR device of claim 8, wherein applying the first set of vertex adjustment values of the distortion mesh and applying the second set of vertex adjustment values of the distortion mesh are performed by at least one of: a vertex shader or a fragment shader.

14. The XR device of claim 8, wherein the at least one processing device is further configured to:
estimate a correction interval comprising at least one of: an estimated latency interval for predicting the second head pose, an estimated latency interval for generating the rendered virtual frame, or an estimated latency interval for displaying the rendered virtual frame; and
determine the second time based on the correction interval.

15. A non-transitory machine-readable medium containing instructions, that when executed cause at least one processing device to:
determine a first set of vertex adjustment values of a distortion mesh;
receive, from a see-through camera of an XR device, image frame data of a scene captured at a first time and at a first head pose by the see-through camera;
apply the first set of vertex adjustment values of the distortion mesh to the image frame data to obtain intermediate image data;
predict, a second head pose at a second time subsequent to the first time;
generate, based on the predicted second head pose, a second set of vertex adjustment values of the distortion mesh;
apply the second set of vertex adjustment values of the distortion mesh to the intermediate image data to generate a rendered virtual frame; and
display, at least one display of the XR device, the rendered virtual frame by the XR device at the second time, the rendered virtual frame comprising a corrected view of the scene.

16. The non-transitory machine-readable medium of claim 15, wherein:
the first set of vertex adjustment values compensates for static differences between the image frame data and the corrected view of the scene; and
the static differences comprise at least one of: a distortion due to a lens of the see-through camera, a chromatic aberration due to the lens of the see-through camera, or a viewpoint difference due to a separation between a location of the see-through camera and a location of a user's eye.

17. The non-transitory machine-readable medium of claim 15, wherein the second head pose comprises a time-warp transformation of the first head pose.

18. The non-transitory machine-readable medium of claim 15, further comprising instructions that when executed, cause the at least one processing device to predict the second head pose comprise instructions that when executed, cause the at least one processing device to:
obtain depth data of the scene captured by a depth sensor of the XR device at the first time;
obtain motion data captured by a motion sensor of the XR device at the first time; and
predict the second head pose based on the depth data and the motion data,
wherein the second head pose comprises a prediction of a rotational position and a translational position of the XR device at the second time.

19. The non-transitory machine-readable medium of claim 18, further comprising instructions that when executed, cause the at least one processing device to predict the second head pose comprise instructions that when executed cause the at least one processing device to:
predict the second head pose by performing a depth-based reprojection to predict the translational position of the XR device at the second time.

20. The non-transitory machine-readable medium of claim 15, wherein applying the first set of vertex adjustment values of the distortion mesh and applying the second set of vertex adjustment values of the distortion mesh are performed by at least one of: a vertex shader or a fragment shader.
